(19) United States
(12) Patent Application Publication
(10) Pub. No.: US 2026/0153103 A1
(43) Pub. Date: Jun. 4, 2026

(54) FLUID LEVEL INDICATOR FOR A HYDRAULIC RESERVOIR

(71) Applicant: EMBRAER S.A., São José dos Campos – SP (BR)

(72) Inventors: Marcelo Luiz MORANDIN, São José dos Campos – SP (BR); Luiz Rodolfo Pereira DIAS, São José dos Campos – SP (BR)

(21) Appl. No.: 19/364,071

(22) Filed: Oct. 21, 2025

(30) Foreign Application Priority Data
Dec. 2, 2024 (BR) 102024025181-4

(51) Int. Cl. F15B 19/00; F15B 1/26; G01F 23/02

(52) U.S. Cl. CPC F15B 19/00; F15B 1/26; G01F 23/02; F15B 2211/857

(57) ABSTRACT

The present invention discloses a fluid level indicator (100) actuated by tape spring (3), preferably of the “constant-force” type, in connection with the piston (6) of the hydraulic actuator (1), so as to keep the load constant throughout the entire stroke of the piston (6). The spring tape (3) has the function of making the connection to the piston (6), providing the flexibility of a spring, in addition to indicating through a graduation, the level of the hydraulic system fluid.

### FIELD OF INVENTION

The present invention is part of the field of hydraulic systems. Specifically, this invention refers to fluid level indicators of reservoirs used in hydraulic systems, such as hydraulic systems applied in the aeronautical, industrial, agricultural sectors, among others.

### BACKGROUND OF THE OF INVENTION

Aeronautical hydraulic systems are employed in aircraft to enhance the operation of the various aircraft maneuvering systems, such as flight controls, landing gear extension, ground steering, opening and closing of aircraft doors, brake activation, etc. Every hydraulic system must have a reservoir, with the functions of accumulating a certain amount of fluid, so that it is possible to supply the system according to the demand of the hydraulic actuators, as well as absorb a certain amount of surplus fluid from the system.

Thus, throughout a typical flight of an aircraft, the hydraulic reservoirs are in constant variation with regard to the amount of fluid in their internal volumes, either increasing or decreasing, depending on several factors, such as, for example, the normal operation of the systems (filling of accumulators, extension or retraction of an unbalanced area actuator), thermal expansion or contraction of the hydraulic fluid due to temperature variation, etc.

Another important function of the reservoirs of hydraulic systems is to maintain a positive back pressure throughout the hydraulic system in order to prevent the phenomenon of cavitation in the hydraulic lines, which occurs due to the formation of vapor bubbles that cause erosion in the metal parts of the various components of the system. The reservoirs of hydraulic systems of the separator piston type can be pressurized by spring, gas or can further be self-pressurized (called “bootstrap”).

In order to mitigate problems that may occur with hydraulic systems, the reservoirs of these aircraft hydraulic systems are equipped with hydraulic fluid level indicators so that there is constant monitoring of the fluids for the purpose of alerting for required maintenance, as well as situations of failures generating leaks during operation.

### BACKGROUND

The most commonly used solutions currently regarding the monitoring of fluid volume in aircraft hydraulic systems have electronic and analog indication, allowing that, after the detection of the fluid level in the reservoir, this fluid level information is sent to the CAS (“Crew Alerting System”) of the aircraft, and such information is available on an analog display incorporated into the component, properly positioned in a way that favors the actual reading of the fluid volume by the operator, during an inspection operation or aircraft maintenance task.

Some prior art documents reveal technologies that fit the same purpose as the present invention, but in which, however, unresolved deficiencies still persist.

Patent U.S. Pat. No. 8,261,612B2, for example, presents a solution to determine the fluid level of a container without the need to apply electrical energy, thus constituting the analog part by means of a drum-type indicator. This implement, basically, consists of a flexible shaft, a pre-tensioning spring and an analog graduated indicator. This type of solution has the disadvantage of having many moving parts, adding weight and size to the system, bringing functional complexity and, consequently, higher cost and a high failure rate.

Therefore, the state of the art would benefit from the introduction of advances in fluid measurement systems in hydraulic reservoirs wherein there is an optimization of the interaction between the components thereof and a consequent reduction in the number of elements that make up the system.

### BRIEF DESCRIPTION OF THE INVENTION

The present invention aims to provide a fluid level indicator actuated by graduated spring tape, preferably of the “constant-force” type, which is in operational connection with the piston of the hydraulic reservoir, in order to maintain the load constant throughout the piston stroke.

Another objective of this invention is to provide a spring-tape that has the triple function of: making the connection to the piston; such connection being by spring-tape possessing elastic flexibility; and being able to indicate by means of the graduation the fluid level of the hydraulic system.

The above listed objectives are achieved by means of a fluid level indicator for a hydraulic reservoir; the indicator comprising a fluid level indication display; wherein the indicator comprises a spring tape operationally connected to a piston of the hydraulic reservoir; wherein a piston movement along its stroke determines a corresponding degree of distension/winding of the spring tape; wherein the spring tape comprises a graduated scale, the graduated scale indicating the fluid level of the hydraulic reservoir; wherein the graduated scale is visible through the fluid level indication display.

### BRIEF DESCRIPTION OF THE FIGURES

In order to assist in the identification of the main characteristics of this invention, the figures are presented, to which reference is made, as follows:

FIG. 1 illustrates a first perspective view of the open hydraulic reservoir with the graduated spring tape retracted in the winding drum connected to the hydraulic reservoir in the completely full position.

FIG. 2 illustrates a second perspective view of the open hydraulic reservoir with the graduated spring tape extended and connected to the center of the piston.

FIG. 3 illustrates a side view of the hydraulic reservoir with the level indicator connected thereto.

FIG. 4 illustrates a first perspective view of the level indicator and display for graduation indication.

FIG. 5 illustrates a second perspective view of the level indicator with the graduated spring tape retracted.

FIG. 6 illustrates a third perspective view of the level indicator with the extended graduated spring tape.

FIG. 7 illustrates a side view of the level indicator and display for graduation indication.

FIG. 8 illustrates a sectional view of the level indicator.

FIG. 9 illustrates a detailed view of the collected graduated spring tape.

FIG. 10 illustrates a detailed view of the extended graduated spring tape.

### DETAILED DESCRIPTION OF THE INVENTION

The fluid level indicator for hydraulic reservoir actuated by graduated spring tape as proposed by this invention represents a robust, compact, and lightweight solution for the hydraulic actuation mechanism, since it incorporates a spring tape, preferably of the “constant-force” type, which serves to make the connection to the piston with the flexibility of a spring and to indicate, through graduation, the fluid level of the hydraulic system.

In this way, with this solution, the need to use pre-tensioning spiral springs is eliminated, considered bulky, of greater weight and with high end-of-stroke loads.

The fluid level indicator (100) for a hydraulic reservoir (for example, an aeronautical hydraulic reservoir) comprises a graduated spring tape (3), preferably of the “constant-force” type, in connection with the piston (6) of the hydraulic reservoir (1), in order to keep the load constant throughout the entire stroke of the piston (6), providing better sizing of the structural parts, use of plain bearings instead of roller bearings, and weight relief.

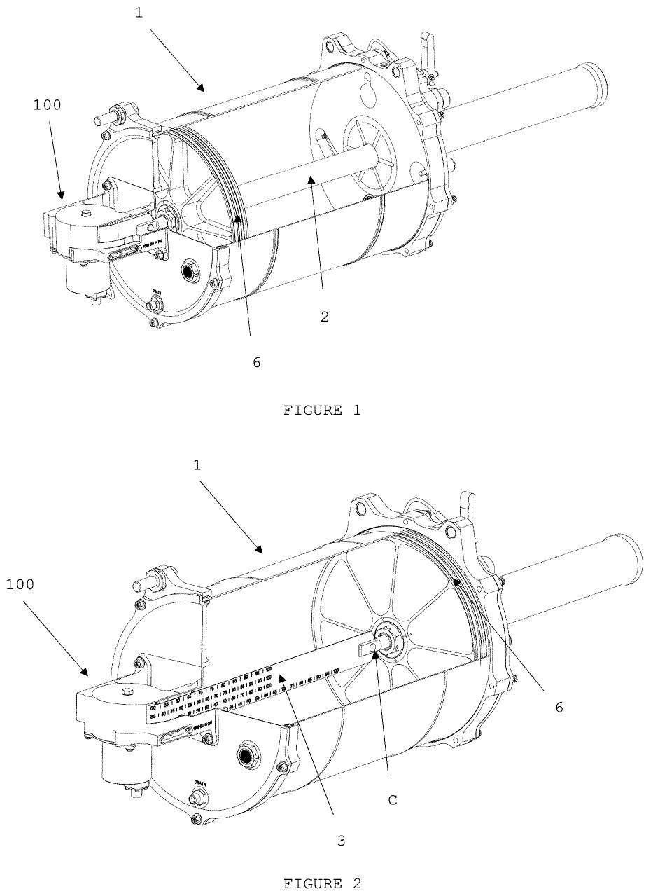

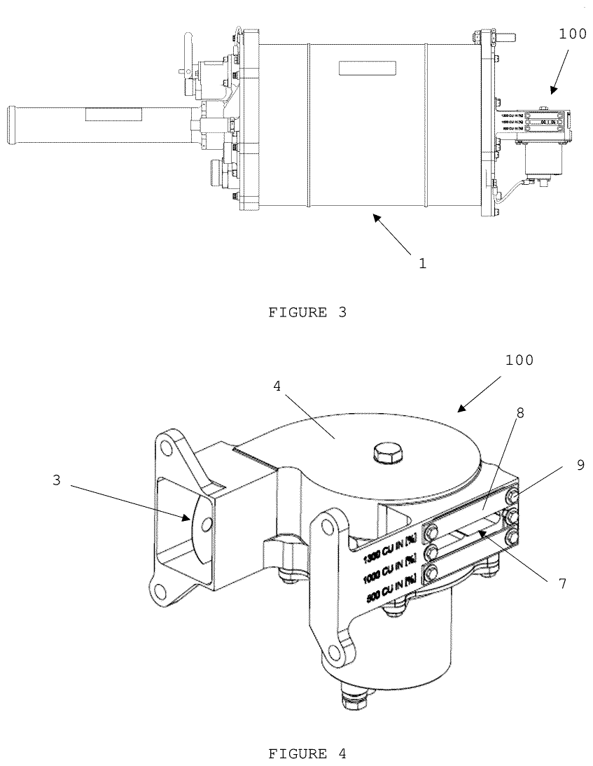

The piston (6) comprises a piston rod (2) and can preferably be of the separator piston type, as illustrated in FIGS. 1 and 2.

The proposed innovation is that the graduated spring tape (3) itself makes the connection with the piston (6) of the hydraulic reservoir (1) and also incorporates the volume scale or scales (3a, 3b, 3c, 3d) on its face, allowing the reading of the fluid volume in the desired scale from at least one sight glass (7) which, in the case of the use of the graduated spring tape (3), would be the most convenient and simple form for an analog display. As an example, the scale (3a, 3b, 3c, 3d) can be expressed as a percentage.

The connection of the graduated spring tape (3) with the piston (6) of the hydraulic reservoir (1) can be made by means of a non-crimped connection (C) between one of the ends of the graduated spring tape (3) and the center of the piston (6), as can be observed in detail in FIG. 2. This type of non-crimped connection allows the free rotating movement of the graduated spring tape (3) in relation to the piston (6), or at least the movement with the least possible friction next to the piston (6), thus preserving the graduated spring tape (3) from any torsional stress.

At the other end, the graduated spring tape (3) is connected directly to a winding drum (5). The winding drum (5) is then properly positioned and connected inside an indicator body (4) (100) that incorporates at least one sight glass (7) for indicating the fluid level as can be better observed in FIG. 4. In addition, it is important to mention that displays with fluid level indication windows (7) can also be located on different sides of the indicator (100), depending on the installation position of the fluid reservoir (1) on the aircraft.

Depending on the displacement of the piston (6) along its stroke, the winding drum (5) makes a rotating movement on its centerline (A), so that a corresponding element or number of the engraved scale (3a, 3b, 3c, 3d) on the graduated spring tape (3) is shown in the windows (7) of the display, thus indicating the current level of fluid in the hydraulic system.

The engraving of the scale(s) can be done directly on the graduated spring tape (3), preferably by laser, before the winding and treatment process of the spring tape (3) (for example, heat treatment). However, other forms of engraving can also be contemplated as being within the scope of the present invention, such as, for example, direct painting on the spring tape (3) with the possibility of finishing being carried out with varnish or even engraving by stamping, etc.

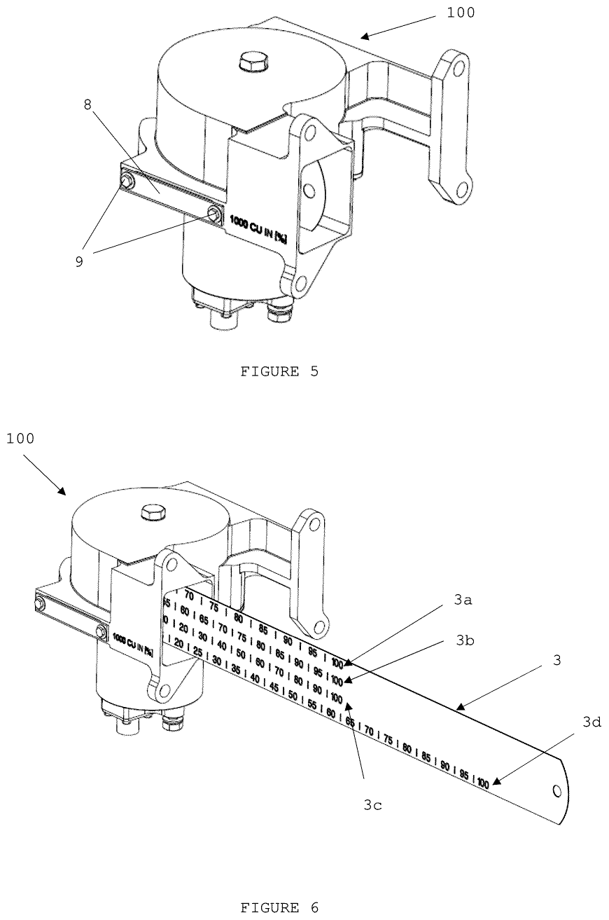

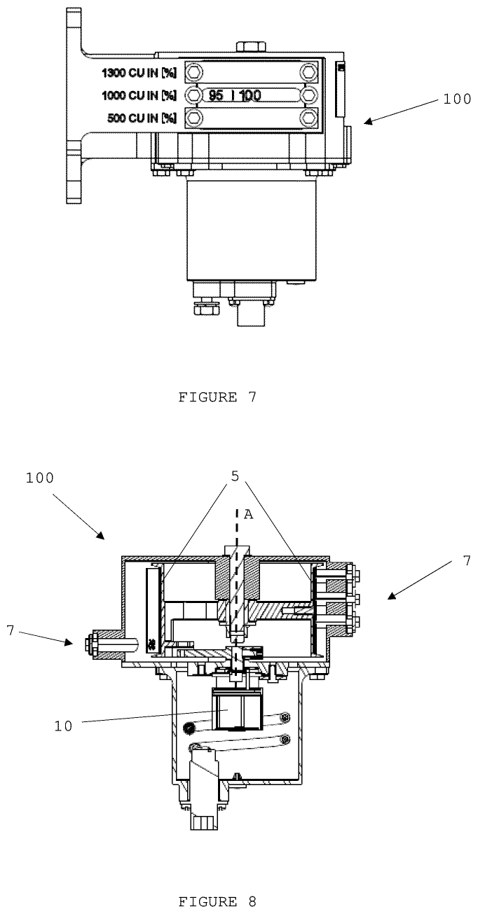

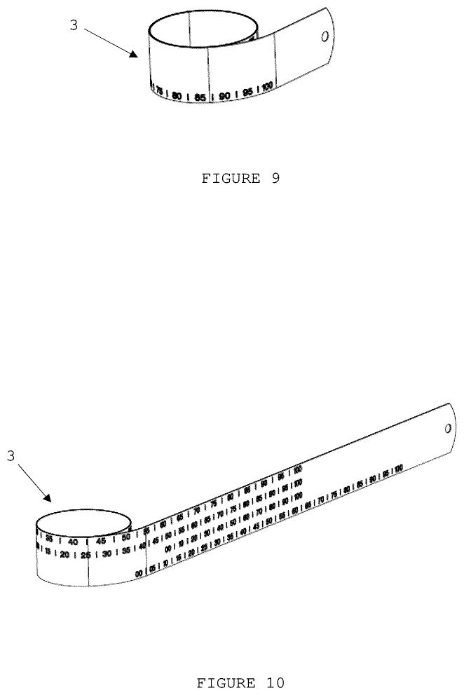

Depending on the width of the graduated spring tape (3) chosen, it is possible to include the engraving of more than one level scale (3a, 3b, 3c, 3d), as can be seen in FIG. 6, so that the indicator (100) can be installed in hydraulic reservoirs of different volumes, according to the number of different scales engraved (for example, two, three, four or more scales). Thus, according to the volume of the hydraulic reservoir to which the level indicator (100) is operationally coupled (for example, volumes of 500, 1000 or 1300 cubic inches, that is, 8.19, 16.39 or 21.30 l, respectively), the user can cap the corresponding sight glasses of the unused level scales (3a, 3b, 3c, 3d). For example, as observed in FIGS. 4 and 5, the blocking of the displays can be done by means of plates (8) fixed to the indicator (100) by means of screws (9) or any other appropriate fixing means. Further, by way of example, the level indicator (100) can be coupled to the reservoir (1) by means of screws or any other appropriate fixing means.

The level indicator (100) activated by graduated spring tape (3) is a robust, compact and light solution for the hydraulic actuation mechanism, since it preferably incorporates a spring tape, preferably of the “constant-force” type that has the triple function of making the connection to the piston; providing the flexibility of a spring; and indicating through the graduation, the fluid level of the hydraulic system.

The design and manufacturing specifications of the spring tape constitute relevant parameters for the proper functioning of the indicator, ensuring the correct force to be demanded from the spring tape, which allows optimal conditions of contrast for reading the recording, as well as meeting the operational life of the spring tape considering wear and fatigue.

In addition, the winding drum (5) can be operationally coupled to any other digital angular position indicator (10) for digital reading of the reservoir fluid level (1) (e.g. potentiometer, resolver, etc.). Thus, in an alternative embodiment, a rotary movement of the winding drum (5) as a result of the movement (winding/unwinding) of the graduated spring tape (3) also activates the digital indicator (10), allowing the fluid level to be read digitally.

Some characteristics can be highlighted as preferential, but not mandatory in the definition of the spring tape (3). For example, the spring tape (3) can be made of 304 stainless steel or similar, with the thickness thereof being preferably defined according to the strength and desired fatigue life of the spring tape (3), and it can vary between 0.2 mm and 1.3 mm in the vast majority of applications.

The width of the spring-tape (3) should be defined based on the force and the number of scales (3a, 3b, 3c, 3d), being wider the greater the desired force and the number of graduated scales (3a, 3b, 3c, 3d) that are to be engraved, or vice versa, whereby it can vary between 10 mm to 80 mm, or more, in some cases.

As for the winding diameter versus winding drum diameter (5), it is important to mention that the winding diameter refers to the average manufacturing diameter of the spring in free state, while the winding drum diameter (5) refers to the working diameter of the spring once installed in the level indicator system (100).

In addition, the average heat treatment temperature can preferably be around 180° C. to 300° C. for a period of 3 to 4 hours, whereby these relationships influence the tonality and contrast of the elements or scale numbers generated by laser engraving. In addition, the laser engraving power can preferably be selected between low, medium or high power.

Although the present application has used aeronautical hydraulic systems to exemplify possible embodiments of the invention, technicians skilled in the art will immediately realize that the present invention can be applied in hydraulic systems common to other sectors, such as industrial, agricultural, etc.

In this way, those skilled in the art will value the knowledge presented herein and will be able to reproduce the invention described in the presented embodiment and in other variants, covered by the scope of the attached claims.

1. Fluid level indicator for a hydraulic reservoir, the indicator comprising a fluid level indication window, wherein:
the indicator comprises a spring tape operationally connected to a piston of the hydraulic reservoir;
wherein a movement of the piston along the stroke thereof determines a corresponding degree of distension of the spring-tape;
wherein the spring tape comprises a graduated scale, the graduated scale indicating the fluid level of the hydraulic reservoir;
wherein the graduated scale is visible through the fluid level indication window.

2. Fluid level indicator, according to claim 1, wherein the spring tape is of the “constant-force” type.

3. Fluid level indicator according to claim 1, wherein piston is of the separator piston type.

4. Fluid level indicator according to claim 1, wherein the connection of the spring tape with the piston of the hydraulic actuator is made through a non-crimped connection between one of the ends of the spring tape and the center of the piston.

5. Fluid level indicator according to claim 1, wherein the graduated scale is directly engraved on the spring tape by laser.

6. Fluid level indicator according to claim 1, wherein the spring tape is made of 304 stainless steel or similar.

7. Fluid level indicator according to claim 1, wherein the thickness of the spring tape varies from 0.2 mm to 1.3 mm.

8. Fluid level indicator according to claim 1, wherein the width of the spring tape ranges from 10 mm to 80 mm.

9. Fluid level indicator according to claim 1, wherein the spring tape undergoes heat treatment at an average temperature of 180° C. to 300° C. for a period of 3 to 4 hours.
